(19) United States
(12) Patent Application Publication
(10) Pub. No.: US 2016/0246788 A1
(43) Pub. Date: Aug. 25, 2016

(54) COLLABORATIVE MEDICAL IMAGING PORTAL SYSTEM

(71) Applicant: VENKATESAN THANGARAJ, Watertown, MA (US)

(72) Inventor: VENKATESAN THANGARAJ, Watertown, MA (US)

(21) Appl. No.: 14/629,475

(22) Filed: Feb. 23, 2015

(51) Int. Cl. G06F 17/30; G06T 1/60; G06F 3/0484; G06T 1/00

(52) U.S. Cl. CPC G06F 17/3028; G06T 1/0007; G06T 1/60; G06F 3/04842; G06T 2210/32

(57) ABSTRACT

A patient clinical image data processing system, comprising a processor, an acquisition interface for acquiring patient medical image data and meta data from one or more medical imaging sources; and a middle-tier server to verify content of the patient medical image data to a predefined DICOM format; and a conversion unit which converts the patient medical image data format which complies with the predefined DICOM format; a comparator configured to process quality checks on the defined DICOM format of the patient medical image based on a reference standards and protocols; a data storage unit, operable for storing the patient medical image data and meta data; a user interface module for providing a custom user interface for interacting with the patient medical image data and meta data to visualize the patient medical image data and meta data from a remote location; a processing interface for providing various tracking and analysis of the patient medical image data and meta data with user privileges.

### FIELD OF THE INVENTION

The invention relates to collaborative medical imaging portal system more particularly to the utilization of collaborative medical imaging portal system user interface supporting clinical trials remotely.

### BACKGROUND AND DESCRIPTION OF PRIOR ART

Existing systems typically acquire image information in clinical trial processes manually. A site with an imaging modality for e.g. CT, MR, X-ray, ultra-sound etc. uses imaging procedures and parameters that seem to produce images in a more or less reproducible way according to each user's expertise with the imaging modality. Existing systems employ largely manual processes in performing the described tasks and these processes offer limited efficiency and data comparability.

Large datasets are routinely collected during clinical trials. Traditionally the endpoints, such as tumor size or QT intervals, were extracted from these datasets and little concern was paid to the original data. As a result no consistent strategy for collecting or storing the data exists. Currently there is great interest in developing biomarkers and historical datasets are important for the development and testing of new algorithms. Having easy access to data from previous studies may greatly enhance biomarker development.

In addition the FDA is becoming increasingly aware of the importance of the source data for clinical trials. As a result it is vital that we ensure the data is handled and maintained in a manner that will pass regulatory scrutiny.

In an attempt to improve the process of data collection, such as imaging, specialized (imaging) Contract Research Organizations (CROs) are being used to facilitate the collection, storage and analysis of data. As a result of the current trial designs many geographically separate groups are required to fully process the data for a study. As a result secure, documented, process-controlled access is required across multiple organizations.

Known systems typically manually perform clinical trial image information management steps that are not comprehensively standardized. This, in conjunction with the lack of interface technology and processes results in an increased burden in performing image-based clinical trials that is compounded by incompatible system results. Further, existing solutions are not readily adapted for use in new trials and environments. A system according to invention principles addresses these deficiencies and problems.

### SUMMARY OF THE INVENTION

A patient clinical image data processing system, comprising: a processor, a non-programmatic, trial specific definition, configuration, and implementation to control the entire system operation for each trial; an acquisition interface for acquiring patient medical image data and meta data from one or more medical imaging sources; and a middle-tier server to verify content of the patient medical image data to a predefined DICOM format; and a conversion unit which converts the patient medical image data format which complies with the predefined DICOM format; a comparator configured to process quality checks on the defined DICOM format of the patient medical image based on a reference standards and protocols; a data storage unit, operable for storing the patient medical image data and meta data; a master indexing engine to organize and index data and meta to provide ultra-fast searches and responses within large data volumes; a user interface module for providing a custom user interface for interacting with the patient medical image data and meta data to visualize the patient medical image data and meta data from a remote location without the requirement of image data transfer to said location preserving the lossless quality of images; a processing interface for providing various tracking and analysis based on trial master control configurations of the patient medical image data and meta data with user privileges; a workflow engine to provide configurable image content workflows that adapts to the needs of a clinical trial that automates and drastically reduces the effort to manage a clinical trial; an integrated operational module that consolidates workflow events to generate metrics providing critical insights into trial management and progress to predict weaknesses and bottlenecks in a real time manner; a clinical efficacy data capture module that utilizes existing electronic data capture systems (EDC), to consolidate efficacy data into commonly used platforms.

A network device may be implemented on a local network to receive patient medical images data or meta data from one or more medical imaging sources in a secure and standardized image file format on a remote network.

Further the said data storage unit includes security, backup and retrieval mechanisms, wherein the security includes access control, maintenance of the audit trails, and protection against data alteration. Further the integration layer module interfaces for data import, export, exporting and the patient image data and meta data are used in a clinical trial and including a communication interface for communicating via a network said patient medical image data and meta data to a trial participant.

According to another aspect, a method for processing patient clinical image data and meta data, providing a non-programmatic, trial specific definition, configuration, and implementation to control the entire system operation for each trial; acquiring patient medical image data and meta data from one or more medical imaging sources; and verifying the content of the acquired patient medical image data by a middle-tier server to adhere to a predefined DICOM format; and converting the patient medical image data to comply with the predefined DICOM format; and processing quality checks on the defined DICOM format of the patient medical image data based on a reference standards and protocols; and storing the patient medical image data and meta data in a data storage unit; providing a master indexing engine to organize and index data and meta to provide ultra-fast searches and responses within large data volumes; providing a custom user interface for interacting with the patient medical image data and meta data to visualize the patient image data and meta data from a remote location without the requirement of image data transfer to said location preserving the lossless quality of images; and providing various tracking and analysis of the patient medical image data and meta data based on trial master control configurations with user privileges via a processing interface; providing a workflow engine configurable image content workflows that adapts to the needs of a clinical study that automates and drastically reduces the effort to manage a clinical trial; and providing an integrated operational module that consolidates workflow events to generate metrics providing critical insights into trial management; providing a clinical efficacy data capture module that utilizes existing electronic data capture systems (EDC), to consolidate efficacy data into commonly used platforms.

The main aspects of the invention is to implement a clinical digital image repository which supports the various existing medical image formats and which is open for expansion to new image modalities. Further aspect of the invention is to reduce time-spent tracking, collating and preparing clinical image data for use in biomarker development and allows improved decision making by providing timely access to clinical image data including viewing of the data.

Yet another aspect of the invention is to provide tools for standardizing the handling of data and thereby enabling secondary analysis of clinical images which will lead to improved clinical trial and product outcomes.

Yet another aspect of the invention is to provide a collaborative environment of internal and external collaborators with respect to clinical trials and as well as integration of core data with other systems

Further another aspect of the invention is to implement a solution that is compliant with regulatory requirements and which conforms to international data standards (i.e. Part 11, audit trials, etc.

### BRIEF DESCRIPTION OF THE DRAWINGS

These and other objects and advantages will become more apparent after consideration of the ensuing description and the accompanying drawings, wherein:

FIG. 1 illustrates a high-level architecture of the Image collaborative portal system, according to an embodiment of the invention.

FIG. 2 schematically shows a detailed patient medical image collaboration system supporting clinical trial, according to an embodiment of the invention.

FIG. 3 is a flow chart schematically showing how the patient medical image data flows supporting clinical trial, according to an embodiment of the invention.

### DETAILED DESCRIPTION

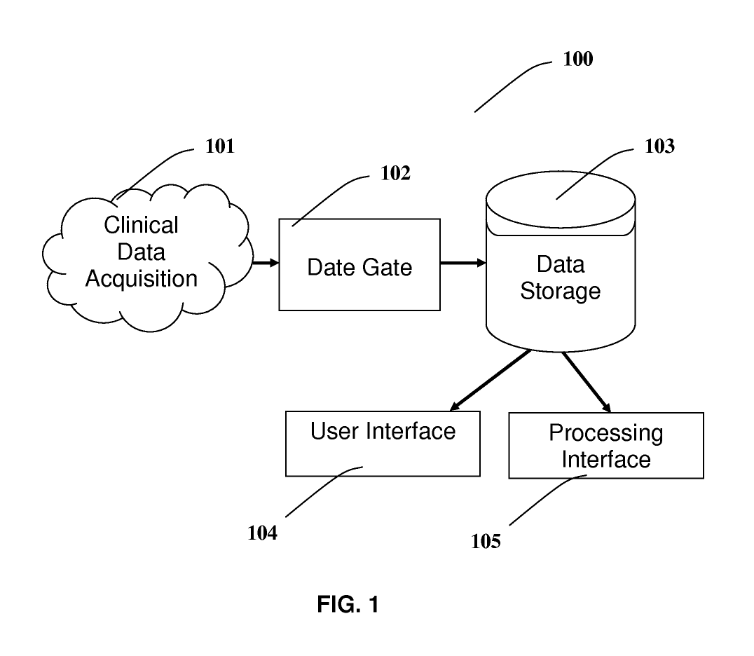

FIG. 1 a high-level architecture of the Image collaborative portal system. The FIG. 1 system comprises a continuous infrastructure comprising the basic system 100 components including Acquisition 101, Data Gate 102, Storage 103, User Interface 104 and Processing Interface 105. The Data Acquisition component 101 is external to the system and represents the instrument that generates the original data. For imaging data this would be the scanner (i.e. MRI, PET, or CT scanner). The Data Gate 102 component is the gatekeeper to the system and serves two primary functions, wherein 1) to convert the data to a suitable and consistent format for storage. 2) to perform a data QA/QC to ensure that any data stored in the system was acquired according to protocol and is of sufficient quality for meeting its intended purpose. The Storage Component 103 or the backend of the system is the data repository. This component includes the security, backup and retrieval mechanisms. Security includes access control, maintenance of the audit trails, and protection against data alteration. The User Interface 104 provides a mechanism for interacting with the data. This will provide viewing tools and the ability to remotely view the data. The Processing Interface 105 provides a method for creating interim results and/or endpoints from the data. When used as biomarkers, the data generally needs some level of processing whether manual or automatic to generate endpoints. Often in the processes of generating endpoints interim analysis are generated which may or may not be stored. Though most of these processing tools will operate external to the proposed repository system, ICP must permit the ability to interface with these tools and potentially store the interim results.

Further the system deals with various classes of users with distinct sets of requirements. Some of the requirements will be common to two or more of the classes and some will be unique to a single class. Each type of user will interact with systems and data differently as a function of their experience, background, skills, and particular tasks being performed. Below is a representative list of user classes, making no claims to be exhaustive. (i) Administrators—the one who oversee systems use; manages configuration and security, overall responsibility for assuring that images are managed in accordance with stated goals and procedures; (ii) Clerical—the one who does day to day acquisition, indexing, and storage of images; (iii) Clinical—the one who primarily reviewing images from specific clinical trials; (iv) Research—the one who access to images (and the associated clinical data) required for development of image based biomarkers; (v) Regulatory—the one who does review of images to be incorporated into formal submissions; (vi) External regulatory authorities—who uses the images for review; (v) Production—where manual and automated application of validated imaging-based biomarkers to images, with the results stored for further statistical analysis and reporting is maintained; (vi) Imaging CROs—the one who populates repository and use tools for reading and generation of endpoints

According to one embodiment to showcase the implementation of the system. Here are some descriptions of specific scenarios of how the system might be used. These scenarios serve as a starting point from which the requirements can be generated in order to accomplish these tasks. A clinical trial is being conducted for a new drug. An imaging CRO is contracted to oversee the process. They receive images from multiple sites. Some images are sent via FTP, others are sent on electronic media by mail while yet others are sent on film by mail. Some of the electronic data is in DICOM and others are in vendor proprietary formats. Upon receiving the image data the imaging CRO does the following: (i) Scans the films into a digital format; (ii) Converts the proprietary formats to DICOM; (iii) Edits the DICOM fields to remove private tags and patient identifying information (annotate); (iv) Adds any essential meta data that is not already with the image data; (v) Performs image QA/QC; (vi) loads the data into the system. After the collection of study data is finished the CRO pulls the images from the repository. A semi-automated software tool is used to segment a region of interest on the images. The segmentation bit map is stored back into the system. The data is blinded and randomized for the read. Multiple radiologists are recruited to interpret the segmentation results and they are allowed to make adjustments to the computer-generated bitmap. The data are read multiple times with each radiologist blinded to the findings of the other radiologists. Results are stored back into the system and final reports are generated. A researcher has developed a new algorithm for segmenting brain tissue. The researcher wants to search the repository for brain scans with particular acquisition parameters. In particular he is interested in scans that have been previously segmented. After selecting appropriate datasets the algorithm is run on the data and the results compared to the previously acquired results. Segmented results are written back to the repository for future use. The project team wants to oversee the results of an ongoing study. They need to pull up selected images and assess the quality as well as examine the segmentation results done by the reader. FDA requests to see images during the submission process. The requested images are pulled from the repository for FDA review. Alternatively, this tool may provide the opportunity for the NDA to contain hyperlinks to images in the repository. The reviewer will have ready access to the original and processed data supporting our application. An additional read is needed for evaluating the study data. A set of images needs to be made available for an offsite radiologist to conduct a blinded review. The results are stored in the repository and available for comparison with earlier reads. A particular study is being conducted in a different location of the company. The project team needs to have quick access to the image data in order to monitor the study. A mirror copy of the study is locally available for retrieval. In the event of an acquisition, divestiture, or in-licensing agreement, it is imperative that both legacy and new image data can be stored & migrated effectively and accessed globally.

The system provides an interface enabling acquisition of images, data, etc. from a site by a user site with a reduced processing burden. The system facilitates addition of more such user sites, in response to sponsor request, without significant additional burden. The system enables trial sites to share their imaging capabilities with different users in a straightforward manner. The interface is able to require that additional information is generated including audit trail identification information, quality control parameters, etc. In particular, clinical trials involving medical images may require infrastructure supporting transport of images (involving transport of high volume data) with functions including maintaining an audit trail, secure messaging and interfacing to a variety of different systems. These systems include imaging modalities (computerized tomography (CT), magnetic resonance (MR), X-ray, ultra-sound and other devices) as well as interfacing to a Radiology Information Systems (RIS) and a Picture Archiving Computerized System (PACS), for example. The clinical trial interface also includes acquisition units for acquiring and processing clinical trial data including data from imaging devices trials. The interface processing involves management of images, blinded read processes for image and data interpretation including single and double blind test processing as well as annotate and authorization management through the use of security protocols (e.g. SSL) together with electronic signature management, for example.

An executable application comprises code or machine readable instruction for implementing predetermined functions including those of an operating system, healthcare information system or other information processing system, for example, in response user command or input. A processor as used herein is a device and/or set of machine-readable instructions for performing tasks. As used herein, a processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display processor or generator is a known element comprising electronic circuitry or software or a combination of both for generating display images or portions thereof. A user interface comprises one or more display images enabling user interaction with a processor or other device. An object comprises a grouping of data, executable instructions or a combination of both or an executable procedure.

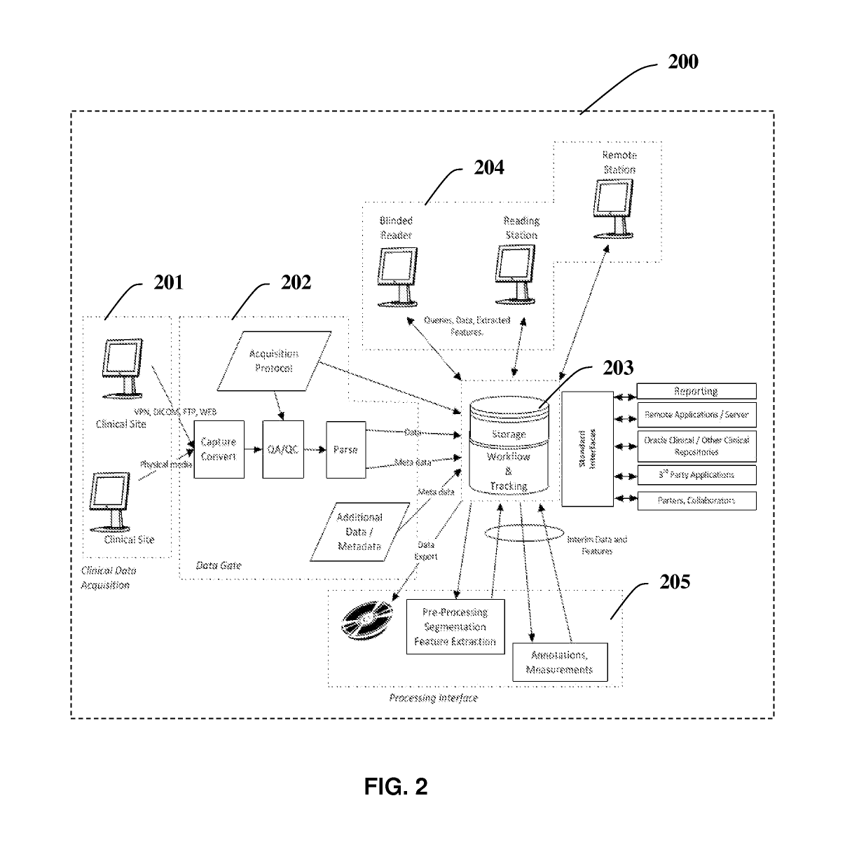

FIG. 2 schematically shows a detailed patient medical image collaboration system supporting clinical trial involving patient medical image data and meta data and facilitating data exchange and communication. The system 200 comprises data acquisition component 201 which is external to the system and represents the instrument that generates the original data. For imaging data this would be the scanner (i.e. MRI, PET, or CT scanner). Transfer of the data can occur either directly by electronic methods such as Web/FTP/DICOM etc. or the data can reside on a physical media (tape, CD, DVD, etc.) which must then be loaded onto the system.

Data Gate component 202 is the gatekeeper to the system and serves two primary functions one is to convert the data to a suitable and consistent format for storage and the other is to perform a data QA/QC to ensure that any data stored in the system was acquired according to protocol and is of sufficient quality for meeting its intended purpose. Prior to entry into ICP the data must undergo a QA/QC process, which will be dependent on the protocol and acquisition parameters. If the data has intrinsic headers containing meta data, such as DICOM data, this data will be parsed from the core data and stored separately. The core data may (or may not) retain the header data when stored in the system. Additional meta data may need to be added if any essential information cannot be parsed from the original data or if fields need to be changed to protect patient confidentiality. Further the system employs a unique feature of the Import module is that QA/QC can be performed before the data is transmitted from acquisition site. This allows project management staff and site personnel to be alerted to issues with acquisition before data is transmitted. In addition, the image transport layer has been developed to allow for very fast image transfers that are orders of magnitude faster than standard HTTP/S or FTP/SFTP protocol. Further, the Data Gate component now has the ability to be an application that can be installed at a remote site thus not requiring the user to log into the ICP through the web interface. This also allows the scheduling of transfers to happen during non-peak times. The application also support image transfers via FTP to any FTP server thus providing for a universal image transfer tool.

The Storage Component 203 is the data repository center of the system. This component includes the security, backup and retrieval mechanisms. Security includes access control, maintenance of the audit trails, and protection against data alteration. Authentication is handled by the processing and user interface components.

The User Interface 204 provides a mechanism for interacting with the data. This will provide viewing tools and the ability to remotely view the data. The primary function of the User interface is to generate search queries and to display the data. There may be different types of users who will each have different needs. For example a blinded reader will need controlled access to a limited portion of the repository and will not have the ability to query the system. A general purpose reading station will require more flexible and powerful interface. A remote station may tie directly to a Mirror Storage for faster response time.

The Processing Interface 205 provides a method for creating interim results and/or endpoints from the data. When used as biomarkers, the data generally needs some level of processing whether manual or automatic to generate endpoints. Often in the processes of generating endpoints interim analysis are generated which may or may not be stored. There are specialized tools, external to the system will do most of the processing of the data. Therefore there must be a mechanism for exporting the data. In addition to an export mechanism, an Application Programming Interface (API) could be created to permit tools to directly access the data within the system. Often during the preliminary processing and analysis steps, the data undergoes one or more sets of transformations. For example, the images may be low-pass filtered to remove noise and then registered to another image set. The next steps in analysis usually require segmentation of the data.

Further, the processing interface enables to view images in both 2D and 3D modes. The system utilizes a proprietary “server” based virtualized rendering to display images to users without having to transmit images to the users' systems. This alleviates a major image transport challenge and allows of instant viewing of images and further more provides a collaborative view where many users can share a desktop. This provides a very controlled environment for remote and local readers and provides IT staff a very simple process to support the process of reads. The Viewer is also capable of being run as a client install in cases where “remote” rending is not possible. The Viewer is 100% identical in both remote and local modes. The client reader is cross platform allowing execution on Windows, Linux and Mac Operating systems. The system also has analysis tools such as linear, ROI, volumetric measurements and SUV calculations.

Further as the processing interface also includes tumor Tracking and Analysis, a RECIST (Response Evaluation Criteria In Solid Tumors) module is used which provides a flexible set of tools for the tracking and analysis of tumors using industry standards such as RECIST, CHOI, etc. The system can be configured to apply standard criterion or can be modified to reflect the needs of a trial. The tool simplifies the tasks performed by the readers through standardization, hanging protocols, integrated eCRF and adjudication.

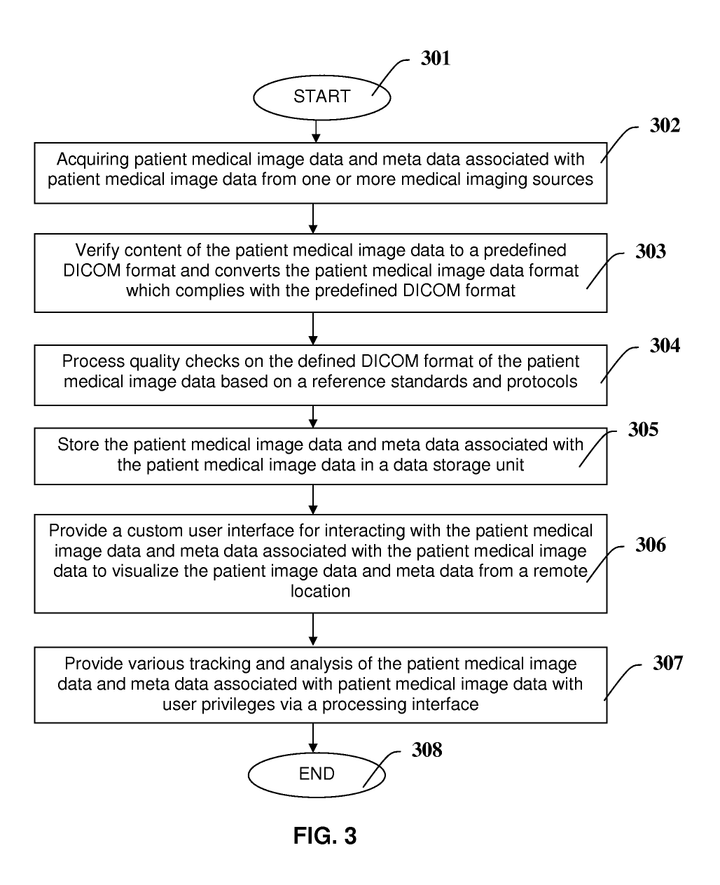

FIG. 3 shows a flow chart of a process employed by the system of FIG. 2 for management of the patient image data and meta data which varies from trial to trial. Each trial's workflow involves numerous steps 301, 302, 303, 304, 305, 306, 307 and 308 for the data to be considered processed. Image Interpretation (Reads) which represents a critical portion of a trials' workflow needs to be adaptable to manage various reading parameters such as Reading Order, Image Display (order of presented images and formatting such as a hanging protocol), Annotations and measurements including the labeling and tracking, multiple readers, and other details. These should be easily linked to all the imaging data for the trial including handing different modalities, time points and acquisition protocols with as little manual intervention as possible.

Further, the system has a custom integration with an open source EDC tools (OC) allows Electronic Case Report Forms developed in OC to be utilized in conjunction with the workflow module to capture reader responses into an eCRF. Logic with the eCRF can be utilized to ensure data submitted is within acceptable norms. The application is web based thus fits well within the ICP's paradigm of a providing a thin client interface. The captured eCRF data can be reviewed monitored and signed by the reader and authorized staff.

Further, the system enables security and access of the patient medical image data and controlled access are important issues with respect to regulatory data. For any study that is run in the ICP, the data must comply with 21 CFR Part 11 which specifies requirements with respect to security and access.

Further, the system allows for the easy archiving and retrieval of study data. In addition, there are regulatory requirements with respect to the retention of this data. The system supports the permanent removal of data but only after ensuring the regulatory storage requirements have been met. Given the large amounts of data, the system provides intelligent methods for performing routine backup and recovery based on the requirements of a study.

Further, the system provides an advanced search engine that allows users to perform a full-text search of any content in the repository. This allows searches on all DICOM tags in addition to any measurements, reports or other data that is stored in the system. The ICP provides a set of well-defined REST based interfaces to allow the ICP to be integrated easily within the enterprise. The integration layer provides interfaces for data import, export, exporting, image display, search and other ICP functions.

Further, the system provides unique image display platform and rendering technology which allows the system to be deployed in virtualized environment leading to cost savings as no specific hardware is required. The system can take advantage of virtualizations on demand resource pooling e.g. CPU cycles, RAM, storage etc. to provide scalable performance as it is required. Additionally, the system is provided as a virtualized machine so installation and configuration is quick and can be validated quickly. As virtualization expands to the cloud, the availability of a large resource pool can be taken advantage of at a very attractive price point.

The system has a configurable trial based portal mechanism that provides a focal point for all trial participants with a central login including sites, sponsors and partners. The portal can be customized through the use of reusable components that can be configured based on system roles.

The system has integrated an standard reporting engine to provide flexible and real time report designing to report delivery through the portal. Reports can be added on the fly and report output is available in one of many formats. Report templates can be customized based on client requirements and can be reused in different trials.

The system provides cost effective, efficient, clinical trial management with improved quality and security at trial sites and comparability of trial results from different trial sites through use of increased automation. The automation is applied in image acquisition and data transfer as well as in rendering patient medical data anonymous. The system is also advantageously integrated with existing workflow task sequence operation at trial sites and provides workflow management for clinical trial management. The system supports multi-site clinical trials as well as trials at just one site. Also system functions may be used for other purposes including supporting training, education, patient identification and site identification, for example.

The system embodiments include different network architectures. In another embodiment, a peer-to-peer architecture is employed in which data and applications are distributed across participating systems. A further embodiment employs a mixed architecture including a central management system and distributed data storage.

The system and processes presented in FIGS. 1-3 are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, any of the functions provided by the systems and process of FIGS. 1-3 may be implemented in hardware, software or a combination of both.

The system is usable in other research environments not just healthcare environments. In a further embodiment, the system integrates image based clinical trial processes and non-image based clinical trial processes (using Electronic Data Capture (EDC) software and data management systems, for example). The system may be offered to users as an ASP (Application Service Provider) hosted service whereby database and analysis applications are offered with pricing models such as pay-per-image, pay-per-patient, pay-per-study, etc. Further, the data and the applications may be provided either by complete or partial outsourcing. The system may also be offered for sale together with services such as implementation or training, for example. In an alternative business model, image-related functions (enhancing existing systems within their environments) may be offered for sale to users separately. Alternatively, in a further embodiment, reimbursement may be made dependent on the particular use to which the trial data is to be put.

Although the invention has been described in connection with a preferred embodiment, it should be understood that various modifications, additions and alterations may be made to the invention by one skilled in the art without departing from the spirit and scope of the invention as defined in the appended claims.

What is claimed is:

1. A patient clinical image data processing system, comprising:
a processor,
a non-programmatic, trial specific definition, configuration, and implementation to control the entire system operation for each trial;
an acquisition interface for acquiring trial specific patient medical image data, meta data and associated data from one or more sources; and
a middle-tier server to verify content of the patient medical image data to a predefined DICOM format; and
a conversion unit which converts the patient medical image data format which complies with the predefined DICOM format;
a comparator configured to process quality checks on the defined DICOM format of the patient medical image based on a reference standards, trial specific definitions and protocols;
a data storage unit, operable for storing the patient medical image data and meta data;
a master indexing engine to organize and index data and meta to provide ultra-fast searches and responses within large data volumes;
a user interface module for providing a custom user interface for interacting with the patient medical image data and meta data to visualize the patient medical image data and meta data from a remote location without the requirement of image data transfer to said location preserving the lossless quality of images;
a processing interface for providing various tracking and analysis based on trial master control configurations of the patient medical image data and meta data with user privileges;
a workflow engine to provide configurable image content workflows that adapts to the needs of a clinical trial that automates and drastically reduces the effort to manage a clinical trial;
an integrated operational module that consolidates workflow events to generate metrics providing critical insights into trial management and progress to predict weaknesses and bottlenecks in a real time manner;
a clinical efficacy data capture module that utilizes existing electronic data capture systems (EDC), to consolidate efficacy data into commonly used platforms.

2. A system according to claim 1, wherein the system is connected to a local network of the medical imaging sources to acquires the patient medical image data, meta data, and associated data.

3. A system according to claim 1, wherein the system is connected to a hosted server comprising patient medical image data and meta data over a secured connection.

4. A system according to claim 1, wherein the patient medical image data and meta data are stored in a computer readable medium at times when there is no provision for the patient medical image data and meta data to be transmitted over the network.

5. A system according to claim 1, wherein the data storage unit includes security, backup and retrieval mechanisms.

6. A system according to claim 1, including an integration layer module to interfaces for data import, export, exporting, image display, search and other core lab functions of the user interface modules.

7. A system according to claim 1, wherein said patient medical image data and meta data are available at plurality of different locations and provide consistency of data layout and presentation between said plurality of different locations.

8. A system according to claim 1, wherein said patient medical image data and meta data is for use in a clinical trial and including a communication interface for communicating via a network said patient medical image data and meta data to a trial participant.

9. A system according to claim 1, wherein said processor determines reading parameters for use in assessment of said trial.

10. A system according to claim 10, wherein said reading parameters are determined consistently for the patient medical image data by display, annotation and measurements including the labeling and tracking for the said trial.

11. A method for processing patient clinical image data and meta data, comprising the activities of:
providing a non-programmatic, trial specific definition, configuration, and implementation to control the entire system operation for each trial;
acquiring patient medical image data and meta data from one or more medical imaging sources; and
verifying the content of the acquired patient medical image data by a middle-tier server to adhere to a predefined DICOM format; and
converting the patient medical image data to comply with the predefined DICOM format; and
processing quality checks on the defined DICOM format of the patient medical image data based on a reference standards and protocols; and
storing the patient medical image data and meta data in a data storage unit;
providing a master indexing engine to organize and index data and meta to provide ultra-fast searches and responses within large data volumes;
providing a custom user interface for interacting with the patient medical image data and meta data to visualize the patient image data and meta data from a remote location without the requirement of image data transfer to said location preserving the lossless quality of images; and
providing various tracking and analysis of the patient medical image data and meta data based on trial master control configurations with user privileges via a processing interface;
providing a workflow engine configurable image content workflows that adapts to the needs of a clinical study that automates and drastically reduces the effort to manage a clinical trial; and
providing an integrated operational module that consolidates workflow events to generate metrics providing critical insights into trial management;
providing a clinical efficacy data capture module that utilizes existing electronic data capture systems (EDC), to consolidate efficacy data into commonly used platforms.
